(19) United States
(12) Patent Application Publication
(10) Pub. No.: US 2016/0354896 A1
(43) Pub. Date: Dec. 8, 2016

(54) 3D-PRINTED POLISHING PAD FOR CHEMICAL-MECHANICAL PLANARIZATION (CMP)

(71) Applicant: PRESIDENT AND FELLOWS OF HARVARD COLLEGE, Cambridge, MA (US)

(72) Inventors: Jennifer A. Lewis, Cambridge, MA (US); Brett G. Compton, Knoxville, TN (US)

(73) Assignee: President and Fellows of Harvard College, Cambridge, MA (US)

(21) Appl. No.: 15/117,615

(22) PCT Filed: Feb. 10, 2015
(86) PCT No.: PCT/US2015/015149

§ 371 Date: Aug. 9, 2016

Related U.S. Application Data
(60) Provisional application No. 61/937,818, filed on Feb. 10, 2014.
(60) Provisional application No. 61/988,555, filed on May 5, 2014.

(51) Int. Cl. B24B 37/22; B33Y 10/00; B32B 5/12; B33Y 70/00; B32B 5/26; B29C 67/00; B33Y 80/00

(52) U.S. Cl. CPC B24B 37/22; B29C 67/0055; B33Y 10/00; B33Y 80/00; B33Y 70/00; B32B 5/26; B32B 5/12; B32B 2262/02; B32B 2264/102; B29K 2101/10

(57) ABSTRACT

A 3D printed polishing pad for chemical-mechanical planarization (CMP) comprises a microlattice including a plurality of layers of extruded filaments arranged in a crisscross pattern. The extruded filaments comprise a polymer composite including a thermoset polymer matrix and filler particles dispersed therein, where the filler particles comprise a length or diameter of no greater than about 200 nm. A three-dimensional network of interconnected voids extends through the microlattice.

### RELATED APPLICATIONS

The present patent document claims the benefit of priority under 35 U.S.C. §119(e) to U.S. Provisional Patent Application Ser. No. 61/937,818, filed on Feb. 10, 2014, and to U.S. Provisional Patent Application Ser. No. 61/988,555, filed on May 5, 2014, both of which are hereby incorporated by reference in their entirety.

### TECHNICAL FIELD

The present disclosure is related generally to three-dimensional printing (3D printing) and more particularly to 3D printed composite structures for precision polishing applications.

### BACKGROUND

Mechanical polishing using grinding tools and abrasives is widely used to obtain smooth and flat surfaces and achieve desired dimensions of various functional or decorative components. Typically, polishing is carried out in a series of steps using progressively finer abrasives until a desired surface finish is achieved.

A specialized precision polishing process is used in the semiconductor industry to obtain planarized and defect-free metal and dielectric layers on silicon wafers. The process, which is referred to as chemical-mechanical polishing or chemical-mechanical planarization (CMP), relies on a chemical reaction between the polishing slurry and the material being polished, in addition to mechanical abrasion. In a typical CMP process, a substrate is placed in direct contact with a rotating polishing pad and a carrier applies pressure to the backside of the substrate. The polishing process is facilitated by the rotational movement of the pad relative to the substrate as slurry is fed to the wafer/pad interface. In addition to the semiconductor industry, CMP is also used for the precision polishing of rigid magnetic hard disks.

A typical CMP polishing slurry includes (abrasive) oxide particles suspended in an oxidizing, aqueous medium, and the polishing pads are typically porous polymeric materials. Depending on the choice of abrasive, oxidizing agent and pad characteristics, the CMP process may be optimized to provide a certain polishing rate while minimizing surface imperfections, defects, and corrosion.

### BRIEF SUMMARY

A 3D printed polishing pad for CMP and a 3D printable composite ink formulation for printing a polishing pad are described herein. Also described are a 3D printed composite structure for CMP and a method of making a 3D printed microlattice that may be used as polishing pad.

The 3D printed polishing pad for CMP comprises a microlattice including a plurality of layers of extruded filaments arranged in a crisscross pattern. The extruded filaments comprise a polymer composite including a thermoset polymer matrix and filler particles dispersed therein, where the filler particles comprise a length or diameter of no greater than about 200 nm. A three-dimensional network of interconnected voids extends through the microlattice.

The method of making a 3D printed microlattice, such as a polishing pad, includes depositing a continuous filament comprising a composite ink formulation including an uncured polymer resin, filler particles having a length or diameter of no greater than about 200 nm, and a latent curing agent on a substrate in a predetermined pattern layer by layer. A microlattice comprising a plurality of layers of extruded filaments arranged in a crisscross pattern is formed, where the extruded filaments are portions of the continuous filament. The composite ink formulation may be cured, preferably after the deposition, to form a polymer composite comprising the filler particles dispersed in a thermoset polymer matrix.

The 3D printable composite ink formulation for printing a polishing pad comprises an uncured polymer resin, a latent curing agent, and filler particles having a length or diameter of no more than about 200 nm. The composite ink formulation comprises a strain-rate dependent viscosity and a plateau value of elastic storage modulus G′ of at least about 10⁴ Pa.

The 3D printed composite structure for CMP comprises a microlattice including a plurality of layers of extruded filaments arranged in a crisscross pattern. The extruded filaments comprise a polymer composite including a thermoset polymer matrix and filler particles dispersed therein, where the filler particles comprise high aspect ratio particles at least partially aligned with the extruded filaments along a length thereof. A three-dimensional network of interconnected voids extends through the microlattice.

### BRIEF DESCRIPTION OF THE DRAWINGS

FIG. 1A shows viscosity as a function of shear rate and FIG. 1B shows moduli data (storage modulus G′ and loss modulus G″) for an exemplary composite ink formulation in comparison with an (unfilled) epoxy resin.

FIGS. 2A-2C show schematics of the 3D printing process, which may also be referred to as 3D deposition, direct-write fabrication or direct-write robocasting.

FIGS. 3A-3B show scanning electron microscope (SEM) images of an exemplary 3D printed composite structure (e.g., 3D printed polishing pad).

FIGS. 4A and 4B show optical sections of the exemplary printed microlattice of FIGS. 3A and 3B.

FIG. 5 shows an optical image of an entire 3D printed microlattice having dimensions of 30 mm×30 mm×1.08 mm.

FIGS. 6A-6B show, respectively, a cross-sectional view of a nozzle having a square opening, and a cross-sectional view of an exemplary microlattice formed from rectangular extruded filaments having a (rounded) square cross-section.

FIGS. 7A-7C show images of an exemplary microlattice comprising a radial grid pattern with both straight and curved extruded filaments.

### DETAILED DESCRIPTION

3D printed microlattice structures formed from extruded filaments comprising a polymer composite may be used as polishing pads for surface finishing applications, such as for the chemical-mechanical polishing or planarization (CMP) of semiconductor chips or hard disks. The microlattice structures may be 3D printed from composite ink formulations that can maintain a filamentary shape and span large gaps without sag after being extruded through a nozzle. The composite ink formulations include filler particles that may be beneficial for the ink rheology and may further serve a functional purpose when the microlattice structures are used for polishing.

### Composite Ink Formulation

The new 3D printable composite ink formulation comprises a mixture of an uncured polymer resin, filler particles, and a latent curing agent. The composite ink formulation has a strain-rate dependent viscosity (and thus can be said to be shear-thinning or viscoelastic) and exhibits a plateau value of shear storage elastic modulus G′ of at least about 10⁴ Pa. When the composite ink formulation is used for 3D printing a polishing pad, the filler particles may comprise a linear size (e.g., length or diameter) of no more than about 200 nm, or no more than about 100 nm, due to the need to reduce or eliminate defects in the polished wafers. The filler particles typically comprise one or more oxides, as described further below.

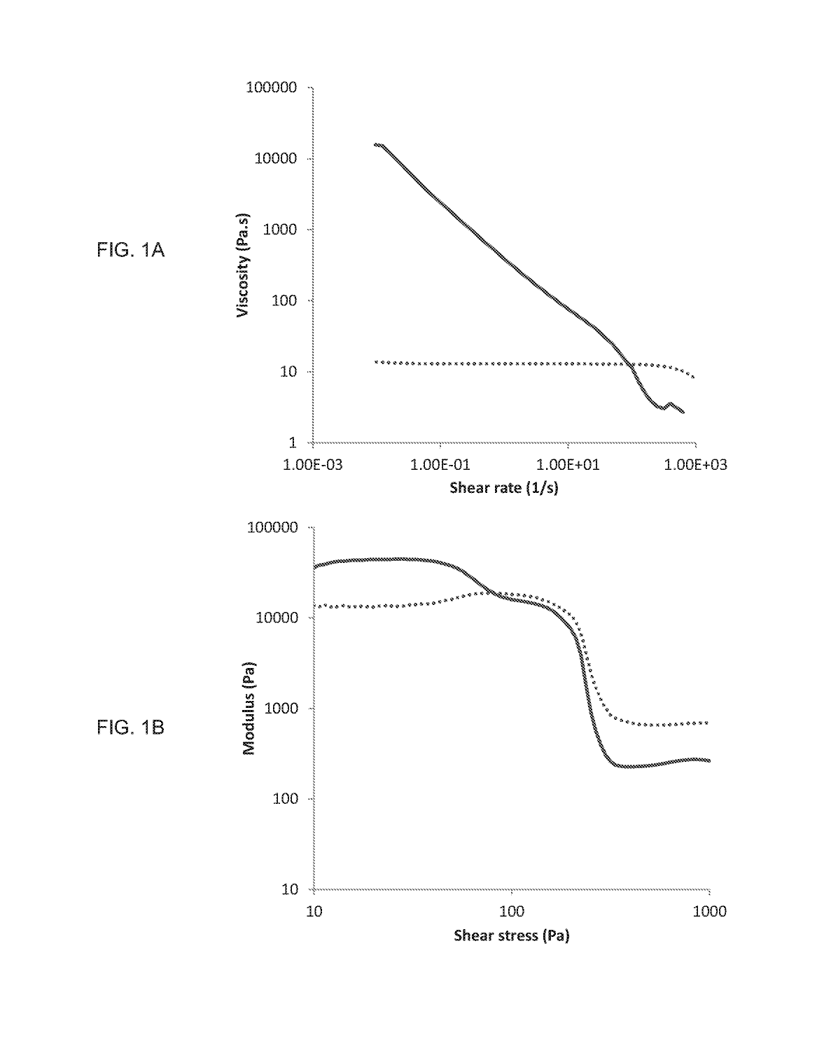

FIG. 1A shows viscosity as a function of shear rate and FIG. 1B shows moduli data (storage modulus G′ and loss modulus G″) for an exemplary composite ink formulation in comparison with an (unfilled) epoxy resin. The composition of the composite ink formulation is set forth in Table 1 (Ex. A). Referring to FIG. 1A, the epoxy resin (without reinforcement or filler particles) exhibits rate-independent Newtonian flow behavior, while the composite ink formulation shows a clear dependence of viscosity on shear rate. FIG. 1B reveals that the composite ink formulations exhibit significant shear thinning and yield stress behavior, again in contrast to the unreinforced epoxy resin. As can be seen, the plateau value of the storage elastic modulus G′ may in some cases be at least about 10⁴, Pa or at least about 10⁵ Pa, and may approach 10⁶ Pa. The composite ink formulation may also exhibit a shear yield stress of at least about 100 Pa.

TABLE 1
Exemplary Ink Formulations

| | Mass in one | | | Parts per | | | | | |
|---|---|---|---|---|---|---|---|---|---|
| | batch (g) | | | hundred resin | | | Mass fraction | | |
| | Example | | | | | | | | |
| | A | B | C | A | B | C | A | B | C |
| Epoxy resin | 30 | 30 | 30 | 100 | 100 | 100 | 0.696 | 0.741 | 0.534 |
| (e.g., Epon 828 resin, | | | | | | | | | |
| Momentive) | | | | | | | | | |
| Silicon oxide particles | 6.6 | 4.8 | 0 | 22 | 16 | 0 | 0.153 | 0.119 | 0 |
| (e.g., Cab-o-sil | | | | | | | | | |
| TS530, Cabot Corp.) | | | | | | | | | |
| Aluminum oxide | 0 | 1.2 | 17.7 | 0 | 4 | 59 | 0 | 0.03 | 0.315 |
| particles | | | | | | | | | |
| (about 50 nm in size) | | | | | | | | | |
| Acetone | 5 | 3 | 7 | 16.7 | 10 | 23.3 | 0.116 | 0.074 | 0.125 |
| Curing agent | 1.5 | 1.5 | 1.5 | 5 | 5 | 5 | 0.035 | 0.037 | 0.027 |
| (e.g., Basionics VS03, | | | | | | | | | |
| BASF) | | | | | | | | | |
| Total | 43.1 | 40.5 | 56.2 | 143.7 | 135 | 187.3 | 1.0 | 1.0 | 1.0 |

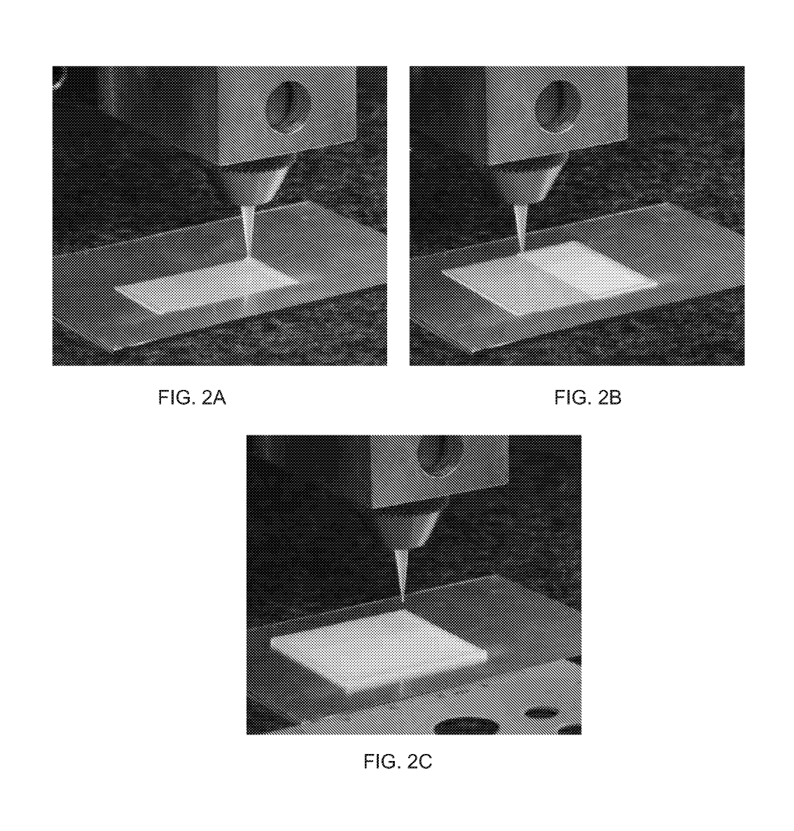

FIGS. 2A-2C show schematics of the 3D printing process, which may also be referred to as 3D deposition, direct-write fabrication or direct-write robocasting. 3D printing typically entails flowing a rheologically-tailored ink composition through a deposition nozzle integrated with a moveable micropositioner having x-, y-, and z-direction capability. As the nozzle is moved, a filament comprising the ink composition may be extruded through the nozzle and continuously deposited on a substrate in a configuration or pattern that depends on the motion of the micropositioner. In this way, 3D printing may be employed to build up 3D structures, such as the polishing pads described in this disclosure, layer by layer. The printing process may involve more than one ink composition and/or more than one nozzle in a serial or parallel printing process.

During printing, the rheology of the ink composition influences the printability, height, and morphology of structures that can be fabricated. At rest, the ink formulation ideally has a sufficiently high elastic storage modulus, G′, and shear yield strength to maintain the printed shape. Under a shear stress, the ink formulation ideally exhibits significant shear thinning to allow flow through small diameter nozzles without requiring prohibitively high driving pressures. When an ink formulation is properly designed, self-supporting structures can be made with filaments that span many times their diameter in free space.

An estimate of the storage modulus, G′, required for a filament to span a given distance with less than 5% sag is given by the following equation:

$${G}^{′} > \frac{1.4 ρ {gL}^{4}}{{D}^{3}} ,$$

where ρ is the mass density, g is the gravitational constant, L is the span length, and D is the filament diameter. The shear yield stress, τ_{γ}, required to achieve a self-supporting structure with a given build height can be calculated as follows:

$${τ}_{Y} = \frac{ρ gh}{\sqrt{3}} ,$$

where h is the structure height. Time-dependent behavior, such as viscoelastic creep or solvent evaporation, is not considered by these equations.

As shown by the data of FIGS. 1A and 1B, filler particles may be incorporated into the ink formulation to alter the rheological properties of the uncured polymer resin. They may also be used to influence the mechanical or other properties of the printed composite structure, which may be a polishing pad, as discussed further below.

The uncured polymer resin selected for the ink formulation may be a thermosetting polymer resin, such as an epoxy resin, a polyurethane resin, a polyester resin, a polyimide resin, or a polydimethylsiloxane (PDMS) resin that undergoes a cross-linking process when cured.

The latent curing agent used in the ink formulation prevents premature curing of the polymer resin; typically, curing is activated by heat exposure after the composite structure has been printed. In conventional 3D printing methods, drying, solidification and/or curing may occur during the printing process such that a deposited layer is partially or fully solidified before the next layer of ink is deposited. Such “on the fly” curing approaches may be required when the printing inks are not engineered with the rheological properties to withstand the layer-by-layer construction of large components. However, premature curing of the ink may lead unsatisfactory bonding between adjacent layers, thereby diminishing the mechanical integrity of the 3D printed structure and/or leading to component warpage due to differential shrinkage. The latent curing agent incorporated in the composite ink formulation may be activated by elevated temperatures in the range of 100° C. to about 300° C. and may have a long pot life, allowing a prepared ink formulation to print consistently over a long time period (e.g., up to about 30 days). Some latent curing agents that may be suitable for the composite ink formulation may be activated by UV light instead of heat. One example of a suitable latent curing agent for epoxy resin is an imidazole-based ionic liquid, such as VSO3 from BASF Group's Intermediates Division. Other commercially available latent curing agents may also be used.

The composite ink formulation may include the uncured polymer resin at a concentration of from about 30 wt. % to about 90 wt. % and the filler particles at a concentration of from about 5 wt. % to about 70 wt. %. The latent curing agent may be present in the ink formulation at a concentration of from greater than 0 wt. % to about 5 wt. %. For 3D printing of polishing pads, the filler particles are more typically present at a concentration of from about 5 wt. % to about 35 wt. %, or from about 8 wt. % to about 20 wt. %.

The concentration of the latent curing agent is more typically specified in terms of weight relative to the weight of the uncured polymer resin. Thus, the latent curing agent may be present at a weight concentration of from greater than 0 to about 15 parts per hundred parts of the uncured polymer resin.

The volume fraction of filler particles may be a stronger predictor of the rheology of the composite ink formulation than the weight fraction of particles. In other words, the rheology of a composite ink formulation including a high weight fraction of a very dense reinforcement may be similar or identical to that of a composite ink formulation containing a low weight fraction of a low density reinforcement—if the volume fraction of the filler particles is about the same for the two formulations. It is useful for this reason to specify a suitable volume fraction of filler particles for the composite ink formulation. Typically, a suitable range of solids loading (particle loading) is from about 5 vol. % to about 60 vol. %, independent of the weight fraction of the particles. For some embodiments, such as when the composite ink formulation is used to fabricate polishing pads, the solids loading may be from about 5 vol. % to about 20 vol. %.

In some cases, the composite ink formulation may further comprise an antiplasticizer such as, for example, dimethyl methyl phosphonate (DMMP). By including the antiplasticizer, the initial viscosity of the epoxy resin may be reduced to allow a higher concentration of filler particles. The antiplasticizer may also contribute to an increased stiffness and strength in the cured composite structure. The antiplasticizer may be present in the ink composition at a concentration of from about 0 wt. % to about 15 wt. %.

As with the latent curing agent, the concentration of the antiplasticizer is more typically specified in terms of weight relative to the weight of the uncured polymer resin. Thus, the antiplasticizer may be present at a weight concentration of from greater than 0 to about 20 parts per hundred parts of the uncured polymer resin.

A number of different types of filler particles may be incorporated into the composite ink formulation for rheology control and/or to influence the mechanical or other (e.g., electrical, thermal, etc.) properties of the printed composite structure. If the composite ink formulation is used for 3D printing of a polishing pad, then it may be beneficial for the filler particles to comprise oxide particles, since such particles are used as abrasives in CMP slurries. For example, the composite ink formulation may include one or more oxides selected from the group consisting of: silica, alumina, ceria, zirconia, titania, zinc oxide, tin oxide, and indium-tin oxide (ITO). Oxide particles of an appropriate size and morphology may have a favorable impact on the rheology of the composite ink formulation while also serving as “fixed abrasives” in the 3D printed polishing pad. The filler particles (e.g., oxide particles) of the composite ink formulation may have a linear size of no greater than about 200 nm, and preferably no greater than about 100 nm, when used for CMP applications to avoid introducing defects into the wafers being polished. The linear size may be understood to be a length in the case of anisotropic particles, and a diameter or width in the case of substantially isotropic particles. For example, the filler particles may have a linear size of from about 1 nm to about 100 nm, or from about 1 nm to about 50 nm, or from about 1 nm to about 10 nm.

Other types of particles may also or alternatively be suitable for the composite ink formulation. In one example, the filler particles may be carbon-based, and thus may comprise carbon. For example, the filler particles may comprise silicon carbide particles and/or particles of another carbide, such as boron carbide, zirconium carbide, chromium carbide, molybdenum carbide, tungsten carbide or titanium carbide. It is also envisioned that the filler particles may comprise substantially pure carbon particles. In other words, the filler particles may comprise carbon particles consisting of carbon and incidental impurities. Examples of suitable carbon particles may include diamond particles, carbon black, carbon nanotubes, carbon nanofibers, graphene particles, carbon whiskers, carbon rods, and carbon fibers, which may be carbon microfibers. The filler particles may also or alternatively comprise clay particles, such as clay platelets. Nitride particles, such as boron nitride, titanium nitride, and/or silicon nitride, may also be suitable. As one of ordinary skill in the art would recognize, the filler particles may be electrically conductive, semiconducting, or electrically insulating.

The silica particles (e.g., fumed silica) incorporated into the exemplary composite ink formulation described in Table 1 may provide elastic stiffness and anti-sag properties to the epoxy resin, while imparting shear thinning behavior which allows the epoxy resin to easily extrude out of small deposition nozzles. A solvent (e.g., acetone) may be added to the resin to lower the viscosity prior to deposition. This may enable significantly higher printing speeds and may reduce the propensity for the ink to curl up against the nozzle during deposition. After extrusion, the solvent rapidly evaporates, aided by the high surface-to-volume ratio of the small filaments (small diffusion length), and the elastic stiffness and yield stress of the ink drastically increases, allowing the printed structure to maintain shape. If the diffusion length in the printed composite structure is too large, the solvent may not be able to evaporate rapidly enough, and residual solvent may cause bubble formation during the elevated temperature curing cycle. The solvent may have a concentration of from 0 wt. % to about 20 wt. % in the composite ink formulation.

The filler particles may comprise high aspect ratio particles that have an aspect ratio of greater than 1, or greater than about 2, where the aspect ratio may be a length-to-width ratio and/or a length-to-thickness ratio. If the filler particles are agglomerated, the aspect ratio relevant to the properties of the ink formulation and the printed composite may be the aspect ratio of the agglomerated particles. If the width and the thickness of a particle are not of the same order of magnitude, the term “aspect ratio” may refer to a length-to-width ratio. The filler particles may comprise, for example, whiskers, fibers, microfibers, nanofibers, rods, microtubes, nanotubes, or platelets. At least some fraction of, or all of, the high aspect ratio particles may have an aspect ratio greater than about 2, greater than about 5, greater than about 10, greater than about 20, greater than about 50, or greater than about 100. Typically, the aspect ratio of the high aspect ratio particles is no greater than about 1000, no greater than about 500, or no greater than about 300. Such high aspect ratio particles may be at least partly aligned during 3D printing of the ink formulation, depending in part on the size and aspect ratio of the particles in comparison to the diameter of the deposition nozzle.

Any high aspect ratio particles incorporated into the ink formulation may have at least one short dimension (e.g., thickness and/or width) that lies in the range of from about 1 nm to about 100 nm, or from about 1 nm to about 50 nm. The short dimension may be no greater than about 20 nm, no greater than about 10 nm, no greater than about 5 nm, or no greater than about 1 nm. The short dimension may also be at least about 1 nm, at least about 10 nm, or at least about 20 nm.

The high aspect ratio particles may have a long dimension (e.g., length) that lies in the range of from about 5 nm to about 200 nm, and is more typically in the range of about 10 nm to about 100 nm. The long dimension may be at least about 5 nm, at least about 10 nm, at least about 20 nm, or at least about 50 nm. The long dimension may also be no greater than about about 150 nm, no greater than about 100 nm, no greater than about 80 nm, or no greater than about 60 nm.

If the filler particles are substantially isotropic particles, then they may have an aspect ratio of about 1 and a linear size (e.g., diameter) that lies within any of the above-described ranges.

The composite ink formulation and the printed composite structure may include filler particles of more than one type, size and/or aspect ratio, allowing for optimization of the rheology of the composite ink formulation as well as enhancement of the mechanical properties of the printed composite structure. For example, the filler particles may comprise a first set of particles added primarily to refine the flow properties of the composite ink formulation, and a second set of particles added primarily to improve the stiffness of the printed composite part. In one example, the second set of particles may include high aspect ratio particles, such as silicon carbide whiskers or carbon fibers, while the first set of particles may be more isotropic in morphology with an aspect ratio lower than the second set of particles, such as clay platelets or oxide particles, which may include agglomerates. The particles (or agglomerates) of the first set may have, for example, an aspect ratio in the range of about 1 to about 4, and the particles of the second set may have an aspect ratio of about 5 to about 20 (e.g., at least about 10, or at least about 15). The aspect ratio of the particles of the second set may also be greater than 20, greater than 50, or greater than 100, for example.

For the CMP pad application, the composite ink formulation may include more than one type of oxide particle, such as silica and alumina particles, or silica, alumina and ceria particles. The composite ink formulation may also include another type of filler particle along with the one or more types of oxide particles.

It should be noted that when a set of particles—or more generally speaking, more than one particle—is described as having a particular aspect ratio, size or other characteristic, that aspect ratio, size or characteristic can be understood to be a nominal value for the plurality of particles, from which individual particles may have some deviation, as would be understood by one of ordinary skill in the art.

As set forth above, the composite ink formulation, which may be used to fabricate polishing pads for CMP, may include the polymer resin at a concentration of from about 30 wt. % to about 90 wt. %. For example, the concentration of the polymer resin in the composite ink formulation may be at least about 30 wt. %, at least about 40 wt. %, at least about 50 wt. %, at least about 60 wt. %, at least about 70 wt. %, or at least about 80 wt. %. The concentration of the polymer resin in the composite ink formulation may also be no greater than about 90 wt. %, no greater than about 80 wt. %, no greater than about 70 wt. %, or no greater than about 60 wt. %.

The concentration of the filler particles in the composite ink formulation may be at least about 5 wt. %, at least about 10 wt. %, at least about 20 wt. %, at least about 30 wt. %, at least about 40 wt. %, at least about 50 wt. %, at least about 60 wt. %, or at least about 70 wt. %. The concentration of the filler particles may also be no greater than about 70 wt. %, no greater than about 50 wt. %, no greater than about 40 wt. %, no greater than about 30 wt. %, no greater than about 20 wt. %, or no greater than about 10 wt. %. In terms of volume fraction, the amount of the filler particles may be at least about 5 vol. %, at least about 10 vol. %, at least about 20 vol. %, at least about 30 vol. %, at least about 40 vol. %, or at least about 50 vol. %. The amount may also be no greater than about 60 vol. %, no greater than about 50 vol. %, no greater than about 40 vol. %, no greater than about 30 vol. %, or no greater than about 20 vol. %.

The latent curing agent may be present in the ink formulation at a concentration of greater than 0 wt. %, such as about 0.1 wt. % or greater, about 1 wt. % or greater, or about 2 wt. % or greater. The concentration of the latent curing agent may also be as high as about 10 wt. %, as high as about 5 wt. %, or as high as about 3 wt. %. Specified in terms of weight relative to the weight of the uncured polymer resin, the latent curing agent may be present at a weight concentration of greater than about 2 parts, greater than about 4 parts, greater than about 8 parts, or greater than about 12 parts per hundred of the uncured polymer resin, and up to about 15 parts per hundred of the uncured polymer resin.

The antiplasticizer, which is optional, may be present in the composite ink formulation at a concentration of up to about 15 wt. %, or up to about 10 wt. %. For example, the concentration of the antiplasticizer may be from about 2 wt. % to about 8 wt. %. Specified in terms of weight relative to the weight of the uncured polymer resin, the antiplasticizer may be present at a weight concentration of greater than about 2 parts, greater than about 4 parts, greater than about 8 parts, greater than about 12 parts, or greater than about 16 parts per hundred of the uncured polymer resin, and up to about 20 parts per hundred of the uncured polymer resin.

### 3D Printed Polishing Pad and Composite Structures

Composite microlattice structures for use as CMP pads may be 3D printed from the composite ink formulations described above.

The 3D printed composite structure comprises a microlattice including a plurality of layers of extruded filaments arranged in a crisscross pattern that defines 3D network of interconnected voids through the microlattice. Being “arranged in a crisscross pattern” means that each extruded filament above a first layer of the extruded filaments includes spanning portions alternating with crossing portions along a length thereof, where a crossing portion contacts an extruded filament from an underlying layer, and a spanning portion extends between consecutive crossing portions unsupported by an extruded filament from the underlying layer. Due to the typically continuous nature of the 3D printing process, the extruded filaments may be portions of a continuous filament deposited in a layer by layer fashion, as described below.

The extruded filaments comprise a polymer composite including a thermoset polymer matrix and filler particles dispersed therein. The filler particles may have a linear size (e.g., length or diameter) of no greater than about 200 nm. The filler particles may also or alternatively include high aspect ratio particles at least partially aligned with the extruded filaments along a length thereof. The 3D printed composite structure may be a 3D printed polishing pad for CMP.

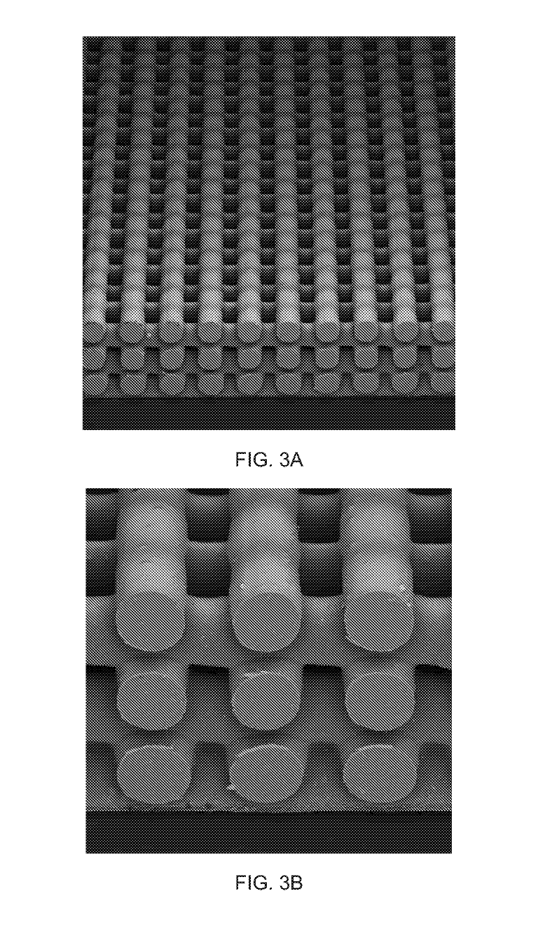

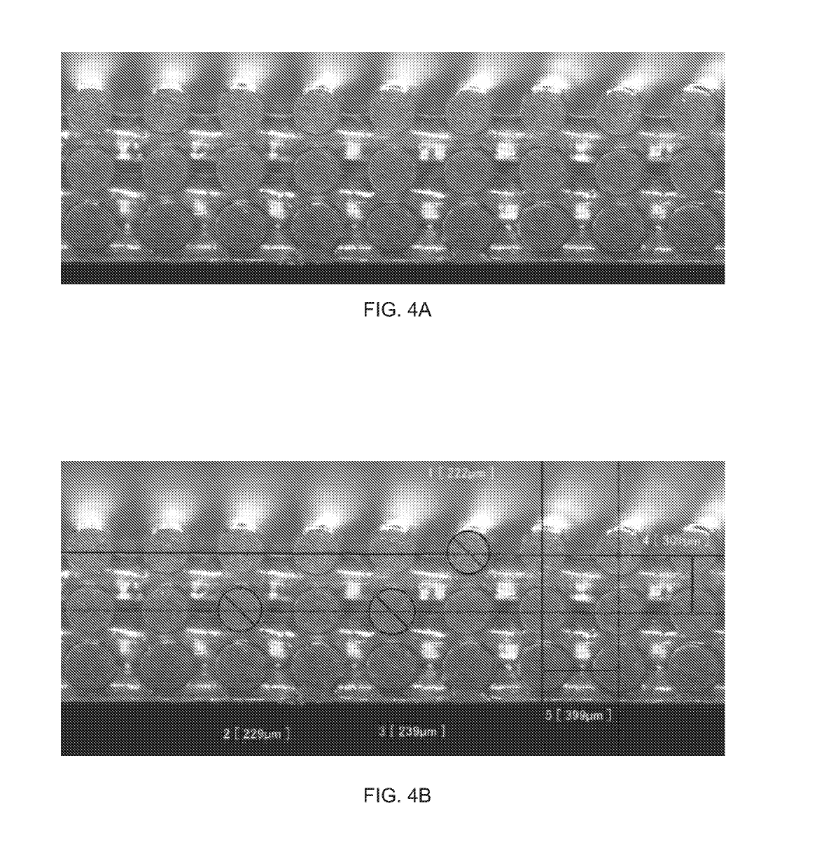

An exemplary 3D printed composite structure is shown in the scanning electron microscope (SEM) images of FIGS. 3A-3B. The images show cross-sectional views of a portion of a 6-layer microlattice at two different magnifications, where the nominal filament diameter is 225 microns. The composite structure was printed with a 200 μm diameter nozzle using a composite ink formulation containing silica particles and epoxy resin, along with acetone and VSO3 (see Table 1). Referring to FIGS. 4A and 4B, which show optical sections of the exemplary printed microlattice, the extruded filaments of can be seen to be spaced about 400 μm apart (center-to-center distance) in the x and y directions, where the z direction is taken to be normal to the layers. The composite ink formulation was pumped through the nozzle at a pressure of 112 psi, and the nozzle was translated at a speed of 50 mm/s with an acceleration of 700 m/s². The extruded filaments have a diameter 10-20% larger than the 200 μm nozzle due to slight “over pumping” during printing.

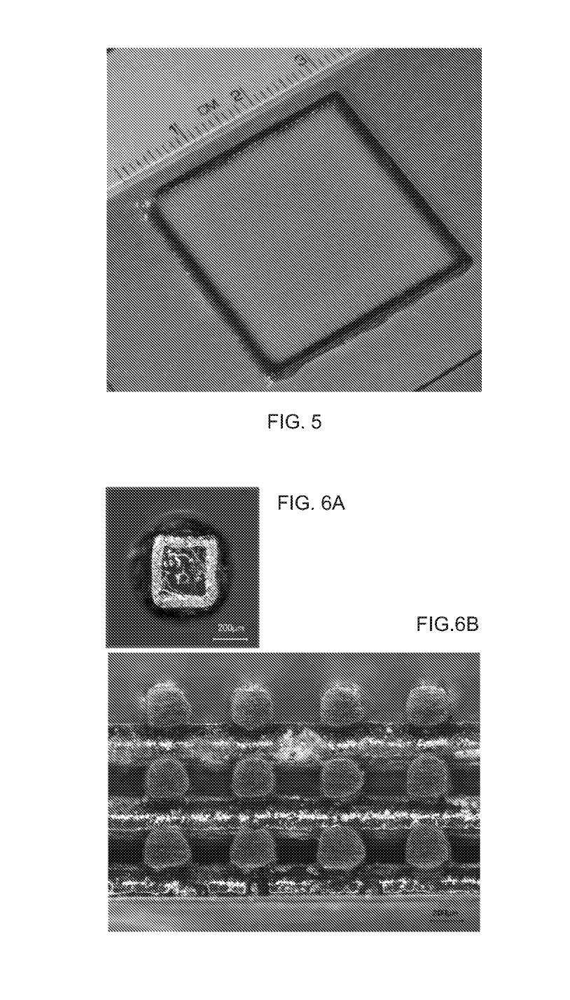

An entire 3D printed microlattice is shown in the optical image of FIG. 5. The dimensions of the microlattice are 30 mm×30 mm×1.08 mm. The border of the printed microlattice appears darker due to an increased density at the edges, which arises from the finite acceleration of the deposition nozzle as it reverses direction at the end of a given row. Due to the path followed by the nozzle during printing, the border of the exemplary printed microlattice has a square shape; however, the nozzle may be controlled such that the border has any desired asymmetric or symmetric shape, such as a circular shape, which may be advantageous for polishing pad applications. For example, the extruded filaments may be deposited along a substantially straight path across the length or width of the microlattice and thus be substantially straight from one edge of the microlattice to the other. Alternatively, due to the flexibility of the fabrication method, partially or fully curved or curvilinear pathways across the microlattice may also be printed.

The extruded filaments have a cross-sectional geometry determined by the shape of the nozzle. For example, filaments extruded through a nozzle having a circular opening may have a cylindrical shape, whereas filaments extruded through a nozzle having a rectangular or square opening may have a rectangular shape with a square (or rounded square; see FIGS. 6A-6B) or a rectangular (or rounded rectangular) transverse cross-section. An advantage of using rectangular extruded filaments over cylindrical filaments for a 3D printed polishing pad is that the contact area between the pad and the wafer may be increased during polishing.

Each of the extruded filaments above the first layer in the crisscross pattern includes spanning portions alternating with crossing portions along a length thereof, as described above. The rheology of the composite ink formulation is designed to such that the storage modulus G′ and the yield strength of the extruded filament are sufficiently high for the spanning portions to extend between the crossing portions without sag and to maintain their shape within the microlattice without distortion, as can be seen for example in the SEM image of FIG. 3B. As would be recognized by one of ordinary skill in the art, the spanning portions have a length determined by the spacing between the extruded filaments in the underlying layer, and the crossing portions have a length defined by the diameter or width of the extruded portions in the underlying layer. Due to the high storage modulus G′ of the extruded filaments (about 10⁴ Pa or greater), the 3D printed composite structure may exhibit a high degree of planarity or flatness that may be “locked in” upon curing, making the composite structure well suited for CMP applications where flatness of the polishing pad is critical.

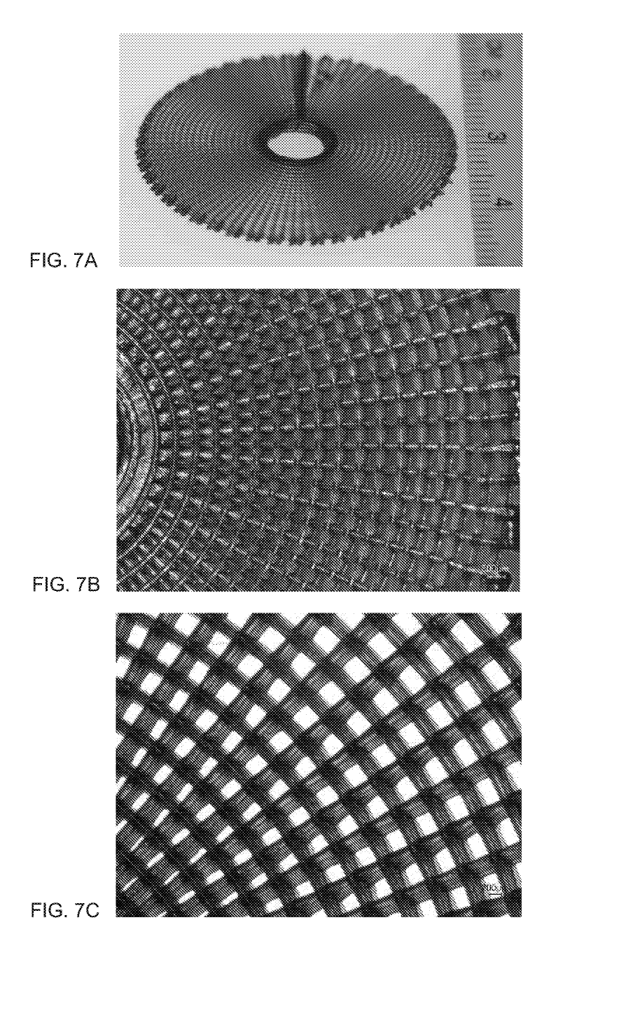

The microlattice may include parallel extruded filaments in some or all of the layers. In some cases, the extruded filaments may also be aligned orthogonal to the parallel extruded filaments in adjacent layer(s). Accordingly, the crisscross pattern may be an orthogonal grid pattern, as shown for example in FIGS. 3A and 3B. The spacing between adjacent filaments within each layer may lie in the range of from about 10 microns to about 200 microns. The spacing may be constant along the length of the extruded filaments, as with parallel extruded filaments, or the spacing may vary along the length of the filaments, as with a microlattice having a radial grid pattern, as shown for example in FIGS. 7A-7C. The microlattice comprising the radial grid pattern includes extruded filaments that are both straight (aligned along radial direction) and curved (aligned with circumferential direction).

As shown in the figures, the crisscross pattern of the microlattice may have a periodic structure in one or more directions. For example, the spacing between adjacent extruded filaments in a given layer may be the same across the layer or may vary periodically across the layer. It is contemplated that some or all of the layers may have a spacing which is the same as or different from that of other layers. For example, in the orthogonal grid pattern of FIG. 3A, the spacing of the filaments along the x direction (across the page) may not be the same as the spacing along the y direction (into the page). The spacing between adjacent filaments in a given layer may be the same as or different from the spacing between alternating layers. In the embodiment shown in FIGS. 4A-4B, the spacing between adjacent filaments in each layer along the x direction (across the page) is larger than the spacing between alternating layers in the z direction (toward the top of the page). This is due in part to the settling of each filament into the underlying filament at the crossing portions. The crisscross pattern of the microlattice may also or alternatively have aperiodicity in one or more directions. In other words, the spacing between adjacent extruded filaments in a given layer need not be uniform across the layer, and the spacing between alternating layers need not be uniform over the thickness or height of the microlattice.

The spacing between alternating layers is typically in the range of from about 50 microns to about 500 microns. The spacing between alternating layers depends on the diameter (or thickness/height) of the extruded filaments, combined with any settling that occurs due to the weight of the filament and overlying layers of filaments. The spacing between alternating layers may be substantially the same over the thickness or height of the microlattice, or the spacing may decrease in the direction of the bottom of the microlattice, due to the settling effect. The microlattice may comprise at least 2 layers, at least 4 layers, at least 6 layers, or at least 8 layers, and typically does not include more than 50 layers, or more than 20 layers. For a typical extruded filament diameter (or thickness/height) of about 50 microns to about 500 microns, the microlattice may thus have a total thickness or height of about 100 microns to about 25 mm.

The spacing between adjacent extruded filaments in each layer and the spacing between alternating layers, along with the number of layers, the size of the filaments and the geometry of the crisscross pattern, determine the three-dimensional network of interconnected voids in the microlattice. Typically, the network of interconnected voids (or void space) comprises from about 20 vol. % to about 80 vol. % of the microlattice. For example, the void space may comprise at least about 20 vol. %, at least about 30 vol. %, at least about 40 vol. %, at least about 50 vol. %, or at least about 60 vol. % of the microlattice. The void space may also comprise at most about 80 vol. %, or at most about 70 vol. % of the microlattice. For a 3D printed composite structure used as a polishing pad, the volume and morphology of the 3D void space may affect the circulation of the polishing slurry during CMP. In contrast to conventional CMP pads which contain only surface grooves or texturing, 3D printed polishing pads include a 3D network of interconnected void passageways (or grooves) that may extend through the entire thickness of the microlattice. The size, shape and extent of the interconnected voids can be controlled by the size, morphology and placement of the extruded filaments. For example, the spacing between adjacent filaments in a given layer determines the width of the void passageways in that layer, while the spacing between (or pitch of) the void passageways is determined by the width or diameter of the filaments in that layer. The depth (or height) of the void passageways in each layer and the total depth (or height) of the 3D interconnected void space is determined by the spacing between alternating layers and the number of layers, respectively. Each of these parameters may be predetermined before 3D printing, and thus the circulation of the slurry through the polishing pad may be controlled and optimized.

As indicated above, the extruded filaments comprise a polymer composite including a thermoset polymer matrix and filler particles dispersed therein. The filler particles can have any of the characteristics (composition, size, aspect ratio, concentration, etc.) described above for the filler particles of the composite ink formulation. As one of ordinary skill in the art would recognize, the filler particles of the polymer composite are the same as the filler particles of the composite ink formulation using for 3D printing. The polymer matrix of the polymer composite may comprise a thermosetting polymer such as epoxy, polyurethane, polyimide, polydimethylsiloxane (PDMS), or polyester.

For the 3D printed polishing pad, the filler particles (e.g., oxide particles) can act as “fixed abrasives” during polishing, further enhancing the CMP process. As the pad is worn down during planarization of a wafer or other substrate, additional abrasive oxide particles within the pad may be exposed to come into contact with the material being planarized.

The 3D printed polishing pad described herein may be used alone or may be attached to a support layer for use. The support layer may be attached to the polishing pad after printing and/or curing. Alternatively, the support layer may be 3D printed along with the microlattice, as described below, either before or after the layers of the extruded filament are deposited, and then bonded to the microlattice during curing. The support layer may comprise a polymeric material, such as one of the thermosetting polymers identified above, and may have a substantially dense microstructure. The thickness of the support layer may be determined by the thickness of the polishing pad, where thinner polishing pads may be attached to thicker support layers for better reliability and ease of handling.

When used in a typical CMP process, a wafer or other substrate to be polished is placed in direct contact with the polishing pad, which is rapidly rotated, and a carrier applies pressure to the backside of the wafer. The polishing process is facilitated by the rotational movement of the pad relative to the wafer as slurry is delivered to the wafer/pad interface. The CMP process relies on a chemical reaction between the polishing slurry and the material being polished, in addition to mechanical abrasion from abrasive particles present in the slurry and in the polishing pad.

### Method of Making a 3D Printed Microlattice Structure

A method of making a 3D printed polishing pad or other microlattice structure may include depositing a continuous filament, which comprises a composite ink formulation including an uncured polymer resin, filler particles having a linear size (e.g., length or diameter) of no greater than about 200 nm, and a latent curing agent, on a substrate in a predetermined pattern layer by layer. A microlattice comprising a plurality of layers of extruded filaments arranged in a crisscross pattern is formed, where the extruded filaments are portions of the continuous filament. The composite ink formulation may be cured, preferably after the deposition, to form a polymer composite comprising the filler particles dispersed in a thermoset polymer matrix.

The “continuous filament” deposited on the substrate may be understood to encompass a single continuous filament of a desired length or multiple filaments having end-to-end contact once deposited to form a continuous filament of the desired length. The nozzle may be moving with respect to an underlying substrate during printing as the continuous filament is deposited along the predetermined pattern. Either the nozzle may be moving or the substrate may be moving, or both may be moving to cause relative motion between the nozzle and the substrate.

Curing of the composite ink formulation may be carried out after deposition of the continuous filament. That is, the curing may be carried out only after deposition is completed and all of the layers have been formed. For example, curing may take place after the microlattice comprising multiple layers of extruded filaments arranged in a crisscross pattern has been formed. As discussed above, premature curing (e.g., during printing of the continuous filament) may lead to unsatisfactory bonding between adjacent layers, thereby diminishing the mechanical integrity of the 3D printed structure (e.g., the polishing pad) and/or leading to component warpage. Because a latent curing agent is employed in the composite ink formulation, premature curing can be avoided. Generally, the curing may entail heating the composite ink formulation at a temperature of from about 100° C. to about 300° C. The curing may also entail more than one heating step, such as a first heat treatment at a temperature from about 100° C.-150° C. and a second heat treatment at a temperature of from about 200° C.-300° C.

The microlattice formed by 3D printing and curing, including the polymer composite comprising the thermoset polymer matrix and filler particles, may have any of the characteristics described elsewhere in this disclosure.

### Experimental Section

Ink. Exemplary inks were prepared by incorporating additives into the epoxy resin via a Thinky Planetary Centrifugal Mixer (Thinky USA, Inc., Laguna Hills, Calif.) using 125 mL glass containers and a custom adaptor. Batches started with 30 grams of Epon 828 resin (Momentive Specialty Chemicals, Inc., Columbus, Ohio). 6.6 gram of TS530 fumed silica (Cabot Corporation, Billerica, Mass.) were added in 2 gram increments, with each addition followed by 3 minutes of mixing and 2 minutes of defoam cycle in the Thinky. Next, the curing agent, Basionics VS03 (BASF, Ludwigshafen, Germany), was added at 5 parts per hundred, relative to the epoxy resin. Finally, 5 grams of acetone were added, and the ink was mixed for 5 minutes and defoamed for 5 minutes in the Thinky mixer.

Printing. An exemplary finished ink was loaded into 3 cc, luer-lock syringes (Nordson EFD, Westlake, Ohio) and centrifuged at 3500 rpm for 10 minutes to remove bubbles. Loaded syringes were then mounted in an HP3 high-pressure adaptor (Nordson EFD) and the assembly was mounted on an Aerotech 3-axis positioning stage (Aerotech, Inc., Pittsburgh, Pa.) for deposition. Ink was driven pneumatically and controlled via an Ultimus V pressure box (Nordson EFD) which interfaces with the Aerotech motion control software. Luer-lock syringe tips (Nordson EFD) were used to dictate filament diameter, and inks were printed onto glass slides covered with Bytac®, PTFE-coated aluminum foil (Saint Gobain Performance Plastics, Worcester, Mass.) to prevent adhesion. Printed parts were then cured at 160° C. for 2 hours. The curing temperature can be used to tune the elastic modulus and hardness of the epoxy to some degree.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A 3D printed polishing pad for chemical-mechanical planarization, the 3D printed polishing pad comprising:
a microlattice comprising a plurality of layers of extruded filaments arranged in a crisscross pattern, the extruded filaments comprising a polymer composite including a thermoset polymer matrix and filler particles dispersed therein, wherein the filler particles comprise a linear size of no greater than about 200 nm, and wherein a three-dimensional network of interconnected voids extends through the microlattice.

2. (canceled)

3. The 3D printed polishing pad of claim 1, wherein the filler particles comprise one or more oxides arc selected from the group consisting of: silica, alumina, ceria, zirconia, titania, zinc oxide, tin oxide, and indium-tin oxide (ITO).

4. The 3D printed polishing pad of claim 1, wherein the filler particles are present in the polymer composite at a concentration of from about 5 wt. % to about 35 wt. %.

5. The 3D printed polishing pad of claim 4, wherein the concentration of the filler particles is from about 8 wt. % to about 20 wt. %.

6. The 3D printed polishing pad of claim 1, wherein the linear size of the filler particles is no greater than about 100 nm.

7. The 3D printed polishing pad of claim 1, wherein the crisscross pattern is an orthogonal grid pattern.

8. The 3D printed polishing pad of claim 1, wherein the crisscross pattern is a radial grid pattern.

9. The 3D printed polishing pad of claim 1, wherein the three-dimensional network of interconnected voids comprises about 20 vol. % to about 80 vol. % of the microlattice.

10. (canceled)

11. The 3D printed polishing pad of claim 1, wherein each of the extruded filaments has a width or diameter of from about 50 microns to about 500 microns.

12. The 3D printed polishing pad of claim 1, wherein a spacing between adjacent extruded filaments in each layer is from about 10 microns to about 2000 microns.

13. The 3D printed polishing pad of claim 1, wherein the thermoset polymer matrix comprises a polymer selected from the group consisting of: epoxy, polyurethane, polyester, polyimide, and polydimethylsiloxane (PDMS).

14-22. (canceled)

23. A 3D printable composite ink formulation for printing a polishing pad, the 3D printable composite ink formulation comprising:
an uncured polymer resin, a latent curing agent, and filler particles comprising a linear size of no more than about 200 nm, and
wherein the composite ink formulation comprises a strain-rate dependent viscosity and a plateau value of elastic storage modulus G′ of at least about 10⁴ Pa.

24. The composite ink formulation of claim 23, wherein the linear size of the filler particles is no more than 100 nm.

25. The composite ink formulation of claim 23, wherein the filler particles comprise one or more oxides are selected from the group consisting of: silica, alumina, ceria, zirconia, titania, zinc oxide, tin oxide, and indium-tin oxide (ITO).

26. The composite ink formulation of claim 23, wherein the filler particles are present at a concentration of from about 5 wt. % to about 35 wt. %.

27. The composite ink formulation of claim 26, wherein the uncured polymer resin is present at a concentration of from about 30 wt. % to about 90 wt. %, and
the latent curing agent is present at a concentration of from greater than 0 wt. % to about 5 wt. %.

28-29. (canceled)

30. The composite ink formulation of claim 23, wherein the uncured polymer resin is selected from the group consisting of an epoxy resin, a polyurethane resin, a polyester resin, a polyimide resin, and a polydimethylsiloxane (PDMS) resin.

31. The composite ink formulation of claim 23, wherein the latent curing agent comprises an imidazole-based ionic liquid.

32-33. (canceled)

34. A method of making a 3D printed microlattice for chemical-mechanical planarization, the method comprising:
depositing a continuous filament on a substrate in a predetermined pattern layer by layer, the continuous filament comprising a composite ink formulation including an uncured polymer resin, filler particles, and a latent curing agent, wherein the filler particles comprise a length or diameter of no greater than about 200 nm;
forming a microlattice comprising a plurality of layers of extruded filaments arranged in a crisscross pattern, the extruded filaments being portions of the continuous filament; and
curing the composite ink formulation to form a polymer composite comprising a thermoset polymer matrix and the filler particles dispersed therein.

35. The method of claim 34, wherein the 3D printed microlattice is a polishing pad.
